(19) United States
(12) Patent Application Publication
(10) Pub. No.: US 2006/0175009 A1
(43) Pub. Date: Aug. 10, 2006

(54) Reactivatable polyurethane hot-melt adhesive

(76) Inventors: Michael Krebs, Hilden (DE); Uwe Franken, Dormagen (DE); Christian Kremer, Juechen (DE)

Correspondence Address: HENKEL CORPORATION, THE TRIAD, SUITE 200, 2200 RENAISSANCE BLVD., GULPH MILLS, PA, 19406, US

(21) Appl. No.: 11/373,784

(22) Filed: Mar. 10, 2006

Related U.S. Application Data
(63) Continuation of application No. PCT/EP04/10175, filed on Sep. 11, 2004.

(30) Foreign Application Priority Data
Sep. 22, 2003 (DE) 103 43 750.9

(51) Int. Cl. C09J 101/00

(52) U.S. Cl. 156/331.7

(57) ABSTRACT

Reactive adhesives are prepared based on polyurethane compositions obtained by reacting at least one type of polyol with at least one type of diisocyanate containing at least 80 percent by weight 2,4′-diphenylmethane diisocyanate. Such adhesives are applied to a surface to be glued of at least one substrate, thermally reactivated separately in time and/or space from application of the adhesive, and then used to join together the substrates to be adhered to each other.

### CROSS-REFERENCE TO RELATED APPLICATIONS

This application is a continuation under 35 USC Sections 365(c) and 120 of International Application No. PCT/EP2004/010175, filed 11 Sep. 2004 and published 14 Apr. 2005 as WO 2005/033164, which claims priority from German Application No. 10343750.9 filed 22 Sep. 2003, each of which is incorporated herein by reference in its entirety.

### FIELD OF THE INVENTION

The present invention relates to a method of bonding substrates using an adhesive that can be thermally reactivated, and to the use of this method in the joining together of substrates.

### DISCUSSION OF THE RELATED ART

Adhesives are nowadays used for a large number of industrial joining processes; hot-melt-type adhesives in particular are increasingly being used for this purpose. As is known, such adhesives belong to the physically setting types of adhesive. At room temperature they are in single-component, solid and solvent-free form and are melted by heating and applied from the melt to the substrate surfaces that are to be joined together. In the case of thermoplastic, non-reactive hot-melt-type adhesives, the substrates are joined together by the solidification of the thermoplastic constituents present as binders in the hot-melt-type adhesive, which thermoplastic constituents may be in the amorphous or semi-crystalline state. Such hot-melt-type adhesives can be melted again by heating and accordingly thermally activated as often as desired; the strength of the adhesive bond is achieved again after cooling of the adhesive. Disadvantages of such hot-melt-type adhesives are their relatively poor thermal stability and the comparatively low final strength of the bonds that are to be achieved with these adhesives.

Reactive hot-melt-type adhesives are nowadays used for demanding bonds which require a higher level of strength and high heat stability of the bond; such reactive hot-melt-type adhesives are either crosslinked by the supply of energy, that is to say by further heating, or cure to the infusible adhesive by means of moisture. The last-mentioned, reactive moisture-curing hot-melt-type adhesives in particular are widely used in industrial practice. These hot-melt-type adhesives, like thermoplastic hot-melt-type adhesives, are applied from the melt; after application, joining of the substrate parts to be bonded and cooling of the melt, rapid physical setting of the hot-melt-type adhesive first takes place by the solidification thereof. In the case of the moisture-reactive hot-melt-type adhesives, this is followed by a chemical reaction of the reactive groups that are still present with the moisture from the surroundings, so that a crosslinked and infusible adhesive forms. Reactive hot-melt-type adhesives based on isocyanate-functional polyurethane prepolymers have become particularly widely used. In general it is desirable for the reactive hot-melt-type adhesives, for example based on moisture-crosslinking reactive polyurethanes, to be in such a form that both the initial strength by solidification and the final strength by moisture crosslinking occur as rapidly as possible, so that the joined building components can either be processed further or finally put into use.

For some manufacturing processes, however, it is desirable for the coating with the adhesive of the substrates that are to be bonded to be separated in terms of space and/or time from the joining together of the substrates. To this end, it is necessary for the process of joining together the precoated substrates to be able to thermally activate or reactivate the adhesive layers.

U.S. Pat. No. 5,340,946 describes a heat-activatable adhesive for the production of wire-scribed conductor track networks. To this end, a film-forming polymer composition is first to be applied to the conductor track to form a dry and non-tacky coating thereon. The conductor track is then to be activated, but not fully cured, by exposure to heat, radiation or ultrasonic energy locally for a period of less than one second after exposure to energy; complete conversion to the “C stage” is not to take place. In a subsequent curing process, the adhesive is then to be converted into the crosslinked form (“C stage”).

EP 0 812 610 A2 describes a method of producing a filter element, in which bands of a hot-melt-type adhesive are to be applied to sheets of paper and, in a later manufacturing step, the hot-melt-type adhesive is to be activated by the supply of heat. The use of reactive hot-melt-type adhesives is not disclosed.

JP 04-300985 A describes a reactive hot-melt-type adhesive composition based on a polyurethane prepolymer comprising a polyol mixture and a polyisocyanate. It is disclosed that this composition has a long working life after coating, as a result of which thermal reactivation is to be avoided. The polyol mixture of this polyurethane prepolymer composition is to be composed of a liquid polyester having a low softening point and a polyester having a high degree of crystallinity. A method in which the application of the adhesive and the joining together of the substrates are carried out separately from one another in terms of space and/or time is not disclosed.

There is, therefore, a need to provide a bonding method in which the adhesive is first applied to substrates that are later to be bonded together and the adhesive layer is thermally activated separately in terms of time and/or space from the application of the adhesive, so that substrates coated in this manner can subsequently be joined together. The cured adhesive layers are to exhibit the good thermal and mechanical stabilities of the reactive hot-melt-type adhesives known hitherto.

### BRIEF SUMMARY OF THE INVENTION

The present invention provides a method of bonding substrates using an adhesive based on reactive polyurethane compositions, the polyurethane composition containing reaction products of at least one polyol and at least one diisocyanate having a content of at least 80 wt. % 2,4′-diphenylmethane diisocyanate (2,4′-MDI), based on diisocyanate composition. The adhesive is first applied from the melt to a surface that is to be bonded of at least one substrate. In a subsequent operation, the adhesive layers are thermally reactivated separately in terms of time and/or space from the application of the adhesive, and the substrates are subsequently joined together.

### DETAILED DESCRIPTION OF CERTAIN EMBODIMENTS OF THE INVENTION

In a preferred embodiment, the thermal reactivation of the adhesive layer can take place within a period of from 2 hours to 3 days, preferably within a period of from 2 hours to 48 hours, after application of the adhesive. To this end, the adhesive layer is heated for the purposes of reactivation to a temperature above the melting temperature and the substrates that are to be joined together are subsequently joined together and optionally pressed together for a short time until the initial strength is obtained by the solidification of the hot-melt-type adhesive. The final strength is then achieved in the conventional manner by subsequent crosslinking by way of moisture. The heating of the hot-melt-type adhesive for the purposes of reactivation can be carried out by any conventional method, that is to say by IR radiator, NIR radiator, in a convection oven, by exposure to microwaves, or directly during the joining operation by means of heatable presses or calenders. The hot-melt-type adhesives that are to be used in the method according to the invention usually have melting temperatures of from 60° C. to 170° C., preferably from 100° C. to 150° C.

For the method according to the invention for bonding substrates there are suitable in particular reactive hot-melt-type adhesive compositions that contain at least one reaction product having free isocyanate groups of 2,4′-diphenylmethane diisocyanate having a content of 2,4′-isomers of at least 80 wt. %, preferably at least 90 wt. % and particularly preferably at least 95 wt. %, and at least one polyether polyol and/or polyalkylene diol having a molecular weight below 1000 and/or a crystalline, semi-crystalline or glass-like amorphous polyester polyol.

In a further embodiment of the method according to the invention, the hot-melt-type adhesive compositions can additionally contain reaction products of 2,4′-diphenylmethane diisocyanate and polyester polyols that are liquid at room temperature and/or polyether polyols having a molecular weight above 1000.

In the hot-melt-type adhesives that are preferably to be used according to the invention, the reaction partners in the preparation of the hot-melt-type adhesive exhibit a NCO/OH ratio of the 2,4′-diphenylmethane diisocyanate that is used to the sum of the polyols of from 1.1 to 2.2, preferably from 1.2 to 1.75, wherein the reaction temperature during the reaction should not exceed 160° C., preferably 130° C.

The hot-melt-type adhesives that are to be used for the method according to the invention can further contain adhesion-enhancing polyisocyanates that are capable of migration and have a vapor pressure of less than 10⁻⁶ hPa at 20° C., these adhesion-enhancing polyisocyanates capable of migration being used concomitantly in an amount of less than 30 wt. %, preferably less than 15 wt. %, based on the total adhesive formulation. In a further embodiment, the hot-melt-type adhesive compositions that are to be used for the method according to the invention can contain organofunctional alkoxysilanes instead of or in addition to the above-mentioned adhesion-enhancing polyisocyanates capable of migration.

The method according to the invention is suitable in particular for the lamination of building components, semi-finished products or structural elements in the automotive supply industry, in container construction, in the shoe industry, in the textile industry and in the construction of apparatus and equipment.

According to the current prior art, “tricks” have to be used, in particular in the automotive supply industry, in order to extend the processing window for the reactivation. For example, decorative elements for interior fittings are intermediately stored with the customer in a chest freezer in order to avoid premature curing of the adhesive layer.

According to the method of the invention, a large number of substrates can be joined together; examples which may be mentioned include decorative films, textile fabrics, paper films, ABS films, foamed PVC films, wooden boards, moulded bodies of wood fibre, or metal films. The adhesive can be applied by any conventional method, for example by spray application, spin-spray application, by knife application, by extrusion using a fishtail extruding die or similar methods. During the intermediate storage of the substrates coated in this manner, it must be ensured that storage takes place in as dry an atmosphere as possible and at a temperature that is not too high, for example at temperatures of up to 30° C. and relative humidities of up to 50%. Surprisingly, there is no impairment of the adhesion and ageing properties of the bonds with adhesive-coated substrates intermediately stored in this manner.

This result is surprising because the hot-melt-type adhesives according to the method of the invention exhibit only isocyanate groups that are slow to react in the prepolymer end groups and it would have been expected that, because of this slowness to react, the adhesion and ageing properties of the bonds according to the method of the invention would be significantly poorer than those in the methods according to the prior art.

If very rapid final strength is to be achieved after the reactivation and pressing together of the substrates that are to be bonded, the adhesive layer can optionally be covered with an aqueous solution of a conventional polyurethane catalyst prior to the reactivation and pressing together of the coated substrates.

The hot-melt-type adhesives used for the method according to the invention should preferably exhibit a low content of monomeric diisocyanates, which should preferably be less than 0.5 wt. % and particularly preferably markedly less than 0.25 wt. %, based on the adhesive composition as a whole. Such adhesives are disclosed, for example, in WO 03/033562 A1 or in WO 03/006521 A1. In the first-mentioned specification, further details of advantageous compositions of hot-melt-type adhesives that are particularly suitable for the method according to the invention are to be found on page 7 to page 13. These disclosures are incorporated by reference into this application.

Catalysts suitable for the above-mentioned covering prior to the reactivation of the adhesive layer are mentioned, for example, on pages 11 to 13 of WO 01/40342; for the embodiment of the catalyst covering, the catalysts mentioned therein are incorporated by reference into the disclosure of this invention.

The 2,4′-MDI-based PUR hotmelts used according to the invention can be catalyzed “gently”, for example by addition of dimorpholino diethyl ether (DMDEE), in order to “customize” the time window for the reactivation.

The invention is to be described hereinbelow with reference to some basic tests, wherein the choice of examples is not to constitute any limitation of the scope of the subject matter of the invention. They show the mode of action of the method that is to be used according to the invention only by way of a model and illustrate its advantages over the prior art in respect of the possibility of significantly extending the reactivation time of the hot-melt-type adhesive without losing the advantageous properties of reactive hot-melt-type adhesives, in particular in their low-monomer form.

### EXAMPLES

In the examples and comparison examples which follow, hot-melt-type adhesives based on 4,4′-MDI and 2,4′-MDI were reacted with polyol mixtures in conventional isocyanate indices (NCO/OH ratios) to form hot-melt-type adhesives, and were then subjected to the bonding method according to the invention.

### Comparison Example (1)

90 parts of a mixture of crystalline, amorphous and liquid polyester polyols having a mean OH number of 32.9 were reacted at 100° C. with 10 parts by weight of 4,4′-MDI (content of the 4,4′-isomer over 99%). The isocyanate index was 1.52.

### Example 2

In the same manner, 90 parts of a mixture of the same polyester diol mixture having a mean OH number of 32.9 were reacted with 10 parts by weight of 2,4′-MDI (content of the 2,4′-isomer over 97.5%), the MDI being added in several portions in order to achieve a viscosity comparable with that of the reference product.

The properties in respect of processing temperature, viscosity in the melt, melt stability and setting time, open time and time window for reactivation are given in the table below both for the comparison example and for Example 2.

It is clear therefrom that both the processing temperature and the processing viscosity and melt stability are largely identical for the bonding method according to the prior art and the method according to the invention. Likewise, the setting time and open time, which are important for further processing, are equal in both cases within the scope of accuracy of measurement.

In order to determine the reactivation, the hot-melt-type adhesive was applied to the substrates by means of a fishtail extruding die in each case in a thin layer (application thickness from 80 to 100 g/m²) and the substrates were then stored intermediately at 30° C. and 50% relative humidity for the time specified in the table, until reactivation. This was followed in both cases by further processing by means of thermal reactivation and lamination by pressing. The time window for the reactivation was significantly extended for the hot-melt-type adhesives according to the invention, so that application of the adhesive and reactivation of the adhesive layer prior to the joining operation can be separated from one another in terms of time and space without difficulty. The longer final curing of from 7 to 14 days in the method according to the invention, compared with from 1 to 5 days in the method according to the prior art (storage conditions 23° C./50% relative humidity), can be compensated for by covering the coated substrates with an aqueous catalyst solution of 0.1 wt. % dimorpholino diethyl ether in water prior to the reactivation and pressing. In this manner, the time required for final curing can be shortened to the “normal” extent of the comparison sample.

As will be seen from Table 2, in a large number of substrates the adhesion spectrum in the method according to the invention is wholly adequate and equivalent compared with the conventional method of the prior art.

TABLE 1

| | |
|---|---|
| | Example 2 |
| Example 1 | (according to |
| (comparison) | the invention) |

| | | | | |
|---|---|---|---|---|
| Processing temperature | 130° | C. | 130° | C. |
| Viscosity at 130° C. | 35.6 | Pas | 33.7 | Pas |
| after 16 hours' storage | 84.6 | Pas | 80.6 | Pas |
| at 130° C. with the exclusion | | | | |
| of moisture, measurement | | | | |
| likewise at 130° C. | | | | |
| Setting time | 12 | s | 13 | s |
| Open time | 22 | s | 23 | s |
| Time window for reactivation | 2-3 | h | 20-30 | h |

TABLE 2
Evaluation of adhesion according to school marking system
after 7 days' curing at 23° C./50% rel. humidity

| | | |
|---|---|---|
| Wood fiber carrier | very good | very good |
| ABS | good | good |
| Foamed PVC film | very good | very good |
| Beech wood | very good | very good |
| Wood fiber carrier | very good | very good |

What is claimed is:

1. A method of bonding a first substrate and a second substrate using a reactive adhesive comprising at least one polyurethane composition having free isocyanate groups, wherein the polyurethane composition comprises reaction products of at least one polyol and at least one diisocyanate having a content of at least 80 wt. % 2,4′-diphenylmethane diisocyanate (2,4′-MDI), said method comprising:
a) applying the reactive adhesive in a layer to a surface that is to be bonded of at least one of said first substrate and said second substrate;
b) thermally reactivating the layer of reactive adhesive on said surface separately in terms of time and/or space from the application of the adhesive; and
c) joining said first substrate and said second substrate together.

2. The method as claimed in claim 1, wherein the polyurethane composition is a hot-melt adhesive.

3. The method as claimed in claim 1, wherein the reactivation according to step b) takes place from 2 hours to 3 days after application of the reactive adhesive according to step a).

4. The method as claimed in claim 1, wherein the reactive adhesive comprises at least one reaction product having free isocyanate groups obtained by reacting:
diisocyanate having a content of 2,4′-diphenylmethane diisocyanate of at least 80 wt. %; and
at least one polyol selected from the group consisting of polyether polyols having number average molecular weights below 1000, polyalkylene diols having number average molecular weights below 1000, and crystalline, semi-crystalline and glass-like amorphous polyester polyols.

5. The method as claimed in claim 4, wherein the reactive adhesive is additionally comprised of reaction products of 2,4′-diphenylmethane diisocyanate and at least one polyol selected from the group consisting of polyester polyols that are liquid at room temperature and polyether polyols having a number average molecular weight above 1000.

6. The method as claimed in claim 1, wherein the reactive adhesive is comprised of at least one adhesion-enhancing polyisocyanate that is capable of migration and has a vapor pressure of less than 10⁻⁶ hPa at 20° C.

7. The method as claimed in claim 6, wherein the reactive adhesive is comprised of less than 30 wt. % of adhesion-enhancing polyisocyanate capable of migration.

8. The method as claimed in claim 1, wherein the reactive adhesive is comprised of one or more organofunctional alkoxysilanes.

9. The method as claimed in claim 1, wherein the NCO to OH ratio of the 2,4′-diphenylmethane diisocyanate that is used to the sum of the polyols is from 1.1 to 2.2 and the reaction temperature during the reaction does not exceed 160° C.

10. The method as claimed in claim 1, wherein the first substrate and the second substrate are pressed together in step c).

11. The method as claimed in claim 1, wherein said substrate having said surface with said layer of reactive adhesive applied thereon is stored at temperatures of up to 30° C. and relative humidities of up to 50% prior to step c).

12. The method as claimed in claim 1, wherein said substrate having said surface with said layer of reactive adhesive applied thereon is covered with an aqueous solution of a polyurethane catalyst after step a) and before step b).

13. The method as claimed in claim 1, wherein the diisocyanate has a content of 2,4′-diphenylmethane diisocyanate of at least 95 wt. %.

14. The method as claimed in claim 6, wherein the content of adhesion-enhancing polyisocyanates capable of migration is less than 15 wt. %.

15. The method as claimed in claim 1, wherein the NCO to OH ratio of the 2,4′-diphenylmethane diisocyanate that is used to the sum of the polyols is from 1.2 to 1.75 and the reaction temperature during the reaction does not exceed 130° C.

16. The method of claim 1, wherein at least one of said first substrate or said second substrate is selected from the group consisting of decorative films, textile fabrics, paper films, ABS films, foamed PVC films, wooden boards, molded bodies of wood fiber, and metal films.

17. The method of claim 1, wherein during step b) the layer of reactive adhesive on said surface is heated above the melting temperature of said reactive adhesive.

18. The method of claim 1, wherein said reactive adhesive has a melting temperature of 100° C. to 150° C.

19. The method of claim 1, wherein said reactive adhesive is applied to said surface in the melt using a method selected from the group consisting of spray application, spin-spray application, knife application, and extrusion using a fishtail extruding die.

20. The method of claim 1, wherein said reactive adhesive comprises less than 0.25 wt. % monomeric diisocyanates.
